(19) United States
(12) Patent Application Publication
(10) Pub. No.: US 2017/0266985 A1
(43) Pub. Date: Sep. 21, 2017

(54) DROPLET EJECTION DEVICE

(71) Applicant: FUJI XEROX CO., LTD., Tokyo (JP)

(72) Inventors: Yukari Motosugi, Kanagawa (JP); Takeshi Zengo, Kanagawa (JP); Hiroyuki Tsukuni, Kanagawa (JP); Kazuhiko Hirokawa, Kanagawa (JP); Takuma Ishihara, Kanagawa (JP); Akira Sakamoto, Kanagawa (JP)

(21) Appl. No.: 15/224,769

(22) Filed: Aug. 1, 2016

(30) Foreign Application Priority Data
Mar. 17, 2016 (JP) 2016-054369

(51) Int. Cl. B41J 11/00

(52) U.S. Cl. CPC B41J 11/002

(57) ABSTRACT

Provided is a droplet ejection device, including: a droplet ejection head in which a longitudinal direction thereof is aligned with a width direction of a recording medium and that forms an image by ejecting a droplet onto the recording medium to be transported along a transporting path; and three or more movable infrared ray irradiation devices that are movably disposed on a downstream side of the recording medium in a transporting direction in relation to the droplet ejection head and that evaporate moisture in the image formed on the recording medium.

### CROSS-REFERENCE TO RELATED APPLICATIONS

This application is based on and claims priority under 35 USC 119 from Japanese Patent Application No. 2016-054369 filed Mar. 17, 2016.

### BACKGROUND

### Technical Field

The present invention relates to a droplet ejection device.

### SUMMARY

According to an aspect of the invention, there is provided a droplet ejection device, including:

a droplet ejection head in which a longitudinal direction thereof is aligned with a width direction of a recording medium and that forms an image by ejecting a droplet onto the recording medium to be transported along a transporting path; and

three or more movable infrared ray irradiation devices that are movably disposed on a downstream side of the recording medium in a transporting direction in relation to the droplet ejection head and that evaporate moisture in the image formed on the recording medium.

### BRIEF DESCRIPTION OF THE DRAWINGS

Exemplary embodiments of the present invention will be described in detail based on the following figures, wherein:

FIG. 1 is a schematic side view showing a configuration of an inkjet recording device according to a first exemplary embodiment;

FIG. 2 is a graph showing a relationship between a temperature of moisture in an image formed by ink droplets ejected onto continuous paper and an irradiation timing by a movable laser apparatus according to the first exemplary embodiment;

FIG. 3 is a schematic side view showing a configuration of an inkjet recording device according to a second exemplary embodiment;

FIG. 4 is a schematic side view showing a configuration of an inkjet recording device according to a third exemplary embodiment; and

FIG. 5 is a schematic sectional view showing a configuration around a fixed laser apparatus according to the third exemplary embodiment.

### DETAILED DESCRIPTION

Hereinafter, an exemplary embodiment of the invention will be described in detail with reference to the drawings. For easy explanation, in each of the drawings, the arrow UP indicates an upper direction of an inkjet recording device 10 which is an example of a droplet ejection device, and a front direction of a page surface means a front direction of the inkjet recording device 10. In addition, hereinafter, a transporting direction of continuous paper P which is an example of a recording medium is simply called a “transporting direction” and the upstream side in the transporting direction and the downstream side direction in the transporting direction are simply called the “upstream side” and “downstream side” respectively, in some cases.

### First Exemplary Embodiment

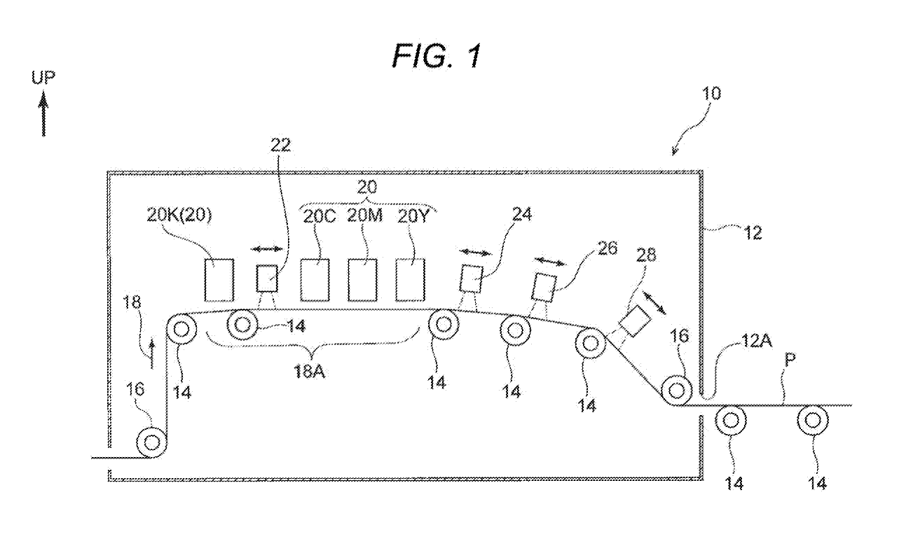

First, the inkjet recording device 10 according to a first exemplary embodiment will be described. As shown in FIG. 1, the inkjet recording device 10 forms an image on the continuous paper P by ejecting ink droplets (liquid droplets) onto the continuous paper P from an inkjet recording head 20 which is provided in an apparatus main body 12.

The continuous paper P is transported to a transporting path 18 which is configured of plural transport rollers 14 and plural tension rollers 16. The plural transport rollers 14 are rotated and support the continuous paper P on the lower side of the continuous paper P in which a front and back direction of the rollers is set to an axis direction. The plural tension rollers 16 are rotated and press the continuous paper P on the upper side of the continuous paper P in which a front and back direction of the rollers is set to an axis direction. The inkjet recording head 20 is disposed at a position facing the continuous paper P to be transported to an image forming area 18A in the transporting path 18 in a vertical direction.

A longitudinal direction of the inkjet recording head 20 is set to a width direction of the continuous paper P to be transported along the transporting path 18 and the inkjet recording head 20 has a length equal to or longer than the width of the continuous paper P. The black (K), cyan (C), magenta (M), and yellow (Y) inkjet recording heads 20 are disposed in that order on the upstream side of the continuous paper P in the transporting direction. Each of the inkjet recording heads 20K, 20C, 20M, and 20Y ejects each of the color ink droplets from above in that order with respect to the continuous paper P.

In addition, a movable infrared ray irradiation device 22 (hereinafter, referred to as a “movable laser device”) which radiates an infrared ray toward the continuous paper P to be transported to the transporting path 18 is disposed between the black (K) inkjet recording head 20K and the cyan (C) inkjet recording head 20C.

Plural (for example, three) movable infrared ray irradiation devices (hereinafter, referred to as the “movable laser devices”) 24, 26, and 28 which radiate the infrared ray toward the continuous paper P to be transported to the transporting path 18 are disposed on the downstream side of the most downstream side yellow (Y) inkjet recording head 20Y and on the upstream side in relation to an outlet port 12A of the continuous paper P in the apparatus main body 12.

Each of the movable laser devices 22, 24, 26, and 28 is individually (independently) movable along the transporting path 18 by a well-known moving mechanism (not shown), respectively. Each of the movable laser devices 24, 26, and 28 is configured to be disposed at different intervals from each other. In addition, each of the movable laser devices 22, 24, 26, and 28 serves as a resonator type vertical cavity surface emitting laser, and is capable of evaporating the moisture in the image formed by ink droplets ejected to the continuous paper P.

More specifically, the movable laser device 22 disposed between the black (K) inkjet recording head 20K and the cyan (C) inkjet recording head 20C radiates an image (mostly a character) formed by the black (K) ink droplets ejected from the inkjet recording head 20K with the infrared ray to evaporate the moisture in the image.

Each of the movable laser devices 24, 26, and 28 disposed on the downstream side of the most downstream side yellow (Y) inkjet recording head 20Y irradiates an image formed by the cyan (C), magenta (M), and yellow (Y) ink droplets ejected from each of the inkjet recording heads 20C, 20M, and 20Y with the infrared ray sequentially to evaporate the moisture in the image.

Examples of the above-described well-known moving mechanism include a guide rail which supports in such a manner that each of the movable laser devices 22, 24, 26, and 28 is movable, a rack-and-pinion which causes each of the movable laser devices 22, 24, 26, and 28 to be moved individually, and an electric motor which drives each pinion to rotate. However, the moving mechanism in the exemplary embodiment is not particularly limited thereto.

In addition, the position of each of the movable laser devices 24, 26, and 28 disposed on the downstream side of the most downstream side yellow (Y) inkjet recording head 20Y is appropriately set depending on a transporting speed of the continuous paper P, an ink type (difference in infrared ray absorbency index in each color), and a type of sheet (difference in the thickness (heat capacity) or difference in the penetration rate). In the first exemplary embodiment, a position of each of the movable laser devices 24, 26, and 28 is set based on the transporting speed of the continuous paper P as an example thereof.

In addition, each of the movable laser devices 22, 24, 26, and 28 is disposed along the transporting path 18 so as to radiate the infrared ray from a normal direction of the continuous paper P in a side view shown in FIG. 1 when viewed from a direction orthogonal to the transporting direction of the continuous paper P. That is, each of the movable laser devices 22, 24, 26, and 28 is disposed such that the optical axes thereof agree with the normal direction of the continuous paper P.

In the inkjet recording device 10, which is configured as described above, according to the first exemplary embodiment, the operation thereof will be described below.

First, each of the movable laser devices 24, 26, and 28 is disposed in an appropriate position, respectively, based on the transporting rate of the continuous paper P. That is, each of the movable laser devices 24, 26, and 28 is individually moved by the well-known moving mechanism such that each of the devices can radiate the infrared ray, sequentially at an appropriate irradiation timing (in the image formed on the continuous paper P, to obtain an optical density exceeding a threshold value serving as a target).

The movable laser device 22 is disposed adjacent to the black (K) inkjet recording head 20K as much as possible. According to this, since the temperature of the moisture in the black (K) image formed on the continuous paper P rapidly increases up to a boiling temperature, bleeding is reduced due to infiltration of moisture into the continuous paper P and lowering of the optical density of the image (mostly a character) can be suppressed and prevented.

When the position of each of the movable laser devices 22, 24, 26, and 28 is confirmed, a print job can be executed. When the print job is executed, each ink droplet is ejected from each of inkjet recording heads 20K, 20C, 20M, and 20Y onto the continuous paper P transported along the transporting path 18 which is configured of the plural transport rollers 14 and the plural tension rollers 16. According to this, the image is formed on the continuous paper P sequentially.

When the image (mostly a character) is formed on the continuous paper P by ejecting the ink droplets from the black (K) inkjet recording head 20K, the infrared ray is radiated from the movable laser device 22. According to this, the temperature of the moisture in the black (K) image formed on the continuous paper P is rapidly increased up to the boiling temperature (100° C.) and then the moisture is evaporated.

In addition, when the image is formed on the continuous paper P by ejecting of each of the ink droplets from the cyan (C), magenta (M), and yellow (Y) inkjet recording heads 20C, 20M, and 20Y, the infrared ray is radiated from the movable laser devices 24, 26, and 28 sequentially. According to this, the temperature of the moisture in the cyan (C), magenta (M), and yellow (Y) images formed on the continuous paper P is increased up to the boiling temperature (100° C.) and then the moisture is evaporated.

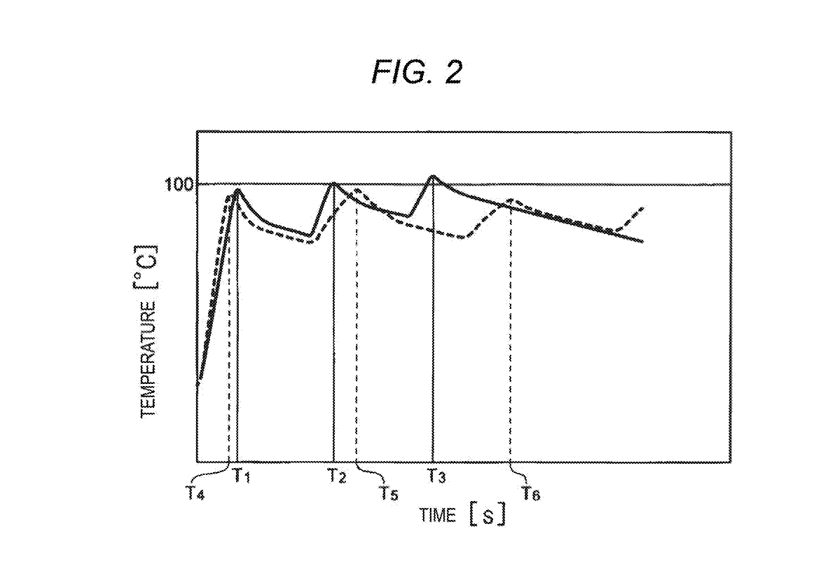

More specifically, as shown by the solid line in FIG. 2, by irradiating the infrared ray from the movable laser device 24 at first, the temperature of the moisture in the image formed by the cyan (C), magenta (M), and yellow (Y) is increased up to the boiling temperature after T1 seconds. In this time, it is preferable that the movable laser device 24 is also disposed adjacent to the yellow (Y) inkjet recording head 20Y (the most downstream side inkjet recording head 20) as much as possible.

Next, when the continuous paper P is transported, the temperature of the moisture in the image is slightly decreased by the transporting time (heat loss to the atmosphere) and by evaporating a part of the moisture in the image. However, by irradiating the infrared ray from the next movable laser device 26, the temperature of the moisture in the image by the cyan (C), magenta (M), and yellow (Y) is increased up to the boiling temperature again after T2 seconds.

When the continuous paper P is further transported, the temperature of the moisture in the image is slightly decreased again by the transporting time (heat loss to the atmosphere) and by evaporating a part of the moisture in the image. However, by irradiating the infrared ray from the next movable laser device 28, the temperature of the moisture in the image by the cyan (C), magenta (M), and yellow (Y) is increased up to the boiling temperature again after T3 seconds.

In this way, in the inkjet recording device 10 according to the first exemplary embodiment, each of the movable laser devices 24, 26, and 28 can increase the temperature of the remaining moisture in the image again at an appropriate irradiation timing before the temperature of the remaining moisture in the image decreases up to a predetermined temperature, in association with transporting of the continuous paper P (heat loss to the atmosphere) and evaporating a part of the image formed on the continuous paper P.

Accordingly, as compared to a configuration in which one or plural infrared ray irradiation devices are fixed and disposed on the downstream side of the most downstream side inkjet recording head 20Y (not shown), that is, a configuration in which the appropriate irradiation timing cannot be selected, the image formed on the continuous paper P is effectively dried, and lowering (diluting) of the optical density of the image formed on the continuous paper P can be suppressed and prevented.

In other words, the bleeding is reduced due to infiltration of moisture into the continuous paper P, the optical density of the image formed on the continuous paper P is improved, and the occurrence of ink strains due to flowing of the ink droplets can be suppressed even in a case where the continuous paper P is low-permeable paper. In a case where the transporting speed of the continuous paper P is changed, the positions of the movable laser devices 24, 26, and 28 are appropriately changed in accordance with the change.

The infrared ray is radiated at the appropriate irradiation timing in the same manner as in the above. For example, in a case where the transporting speed of the continuous paper P is set at half speed, as shown in a dashed line of FIG. 2, by irradiating the infrared ray from the movable laser device 24 at first, the temperature of the moisture in the image by the cyan (C), magenta (M), and the yellow (Y) increases up to the boiling temperature after T4 seconds.

Next, when the continuous paper P is transported, the temperature of the moisture in the image is slightly decreased by the transporting time (heat loss to the atmosphere) and by evaporating a part of the moisture in the image. However, by irradiating the infrared ray from the next movable laser device 26, the temperature of the moisture in the image by the cyan (C), magenta (M), and yellow (Y) is increased up to the boiling temperature again after T5 seconds.

When the continuous paper P is further transported, the temperature of the moisture in the image is slightly decreased again by the transporting time (heat loss to the atmosphere) and by evaporating a part of the moisture in the image. However, by irradiating the infrared ray from the next movable laser device 28, the temperature of the moisture in the image by the cyan (C), magenta (M), and yellow (Y) is increased up to the boiling temperature again after T6 seconds.

In this way, a timing of chaining the position (interval) of each of the movable laser devices 24, 26, and 28 is set to a timing before the print job is executed after the transporting speed of the continuous paper P (or, the type of the ink or the type of the sheet) is changed. In a case where the appropriate irradiation timing is obtained by changing the transporting speed of the continuous paper P, a configuration, in which three or more separated movable laser devices 24, 26, and 28 are disposed on the downstream side of the most downstream side inkjet recording head 20Y, is particularly effective.

In addition, each of the movable laser devices 22, 24, 26, and 28 is disposed along the transporting path 18 so as to radiate the infrared ray from the normal direction of the continuous paper P, in a side view when viewed from a direction orthogonal to the transporting direction of the continuous paper P. Accordingly, as compared to the configuration in which each of the movable laser devices 22, 24, 26, and 28 radiates the infrared ray in a direction oblique to the normal direction of the continuous paper P, the evaporation of the moisture in the image formed on the continuous paper P is accelerated.

In addition, after two movable laser devices 26 and 28 which are disposed on the downstream side in relation to the movable laser device 24 increase the temperature up to the boiling temperature by the movable laser device 24, since the infrared ray is radiated with respect to the remaining moisture in the image in which the temperature of the remaining moisture is slightly decreased in association with transporting of the continuous paper P (heat loss to the atmosphere) and evaporating a part of the image formed on the continuous paper P, to increase the temperature of the remaining moisture to the boiling temperature again, less output in the infrared ray is required as compared to when the movable laser device 24 is used.

For example, in a configuration in which one infrared ray irradiation device elongated in a transporting direction is fixed and disposed on the downstream side of the most downstream side inkjet recording head 20Y (not shown), since the density is lowered when the speed of the temperature increase is decreased (since the lowering of the optical density is suppressed), the output of the infrared ray is not be able to be reduced. However, since the output of the infrared ray can be individually set in the movable laser devices 24, 26, and 28 according to the first exemplary embodiment, the reduction of the output can be achieved when considering the whole configuration. Accordingly, power consumption of the inkjet recording device 10 can be reduced.

In the first exemplary embodiment, the three movable laser devices 24, 26, and 28 are disposed on the downstream side of the inkjet recording head 20Y on the most downstream side, but the configuration is not limited thereto. At least two movable laser devices 24 and 26 may be disposed in addition to the movable laser device 22. In addition, the movable laser devices 22, 24, 26, and 28 are disposed on the downstream side of each color of the inkjet recording heads 20K, 20C, 20M, and 20Y, respectively.

In other words, the movable laser device 22 may be disposed between the inkjet recording head 20K and the inkjet recording head 20C, the movable laser device 24 may be disposed between the inkjet recording head 20C and the inkjet recording head 20M, the movable laser device 26 may be disposed between the inkjet recording head 20M and the inkjet recording head 20Y, and the movable laser device 28 may be disposed on the downstream side of the inkjet recording head 20Y. In this case, inter-color bleeding or color mixing can be effectively suppressed and prevented.

### Second Exemplary Embodiment

Next, an inkjet recording device 10 according to a second exemplary embodiment will be described. Note that the same reference numerals are appended to locations corresponding to those in the first exemplary embodiment, and detailed explanation (including common operation) is omitted as appropriate.

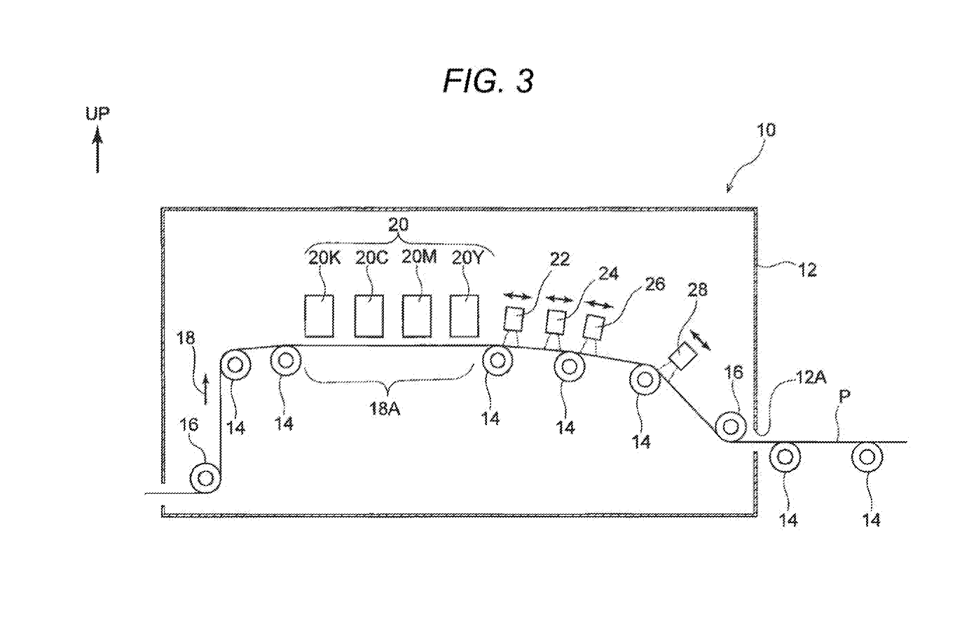

As shown in FIG. 3, in the inkjet recording device 10 according to the second exemplary embodiment, the movable laser device 22 is not disposed between the black (K) inkjet recording head 20K and the cyan (C) inkjet recording head 20C, and the movable laser devices 22, 24, 26, and 28 are disposed on only the downstream side of the most downstream side yellow (Y) inkjet recording head 20Y.

Accordingly, in the inkjet recording device 10 according to the second exemplary embodiment, with respect to the changes in the transporting speed of the continuous paper P (or, the type of the ink or the type of the sheet), the scope of choices for the irradiation timing for irradiating the infrared my is wider than the above-described first exemplary embodiment. Accordingly, the image formed on the continuous paper P is effectively dried even more significantly than in the first exemplary embodiment. Therefore, lowering (diluting) of the optical density of the image formed on the continuous paper P can be suppressed and prevented.

### Third Exemplary Embodiment

Next, an inkjet recording device 10 according to a third exemplary embodiment will be described. Note that the same reference numerals are appended to locations corresponding to those in the first and second exemplary embodiments, and detailed explanation is omitted as appropriate.

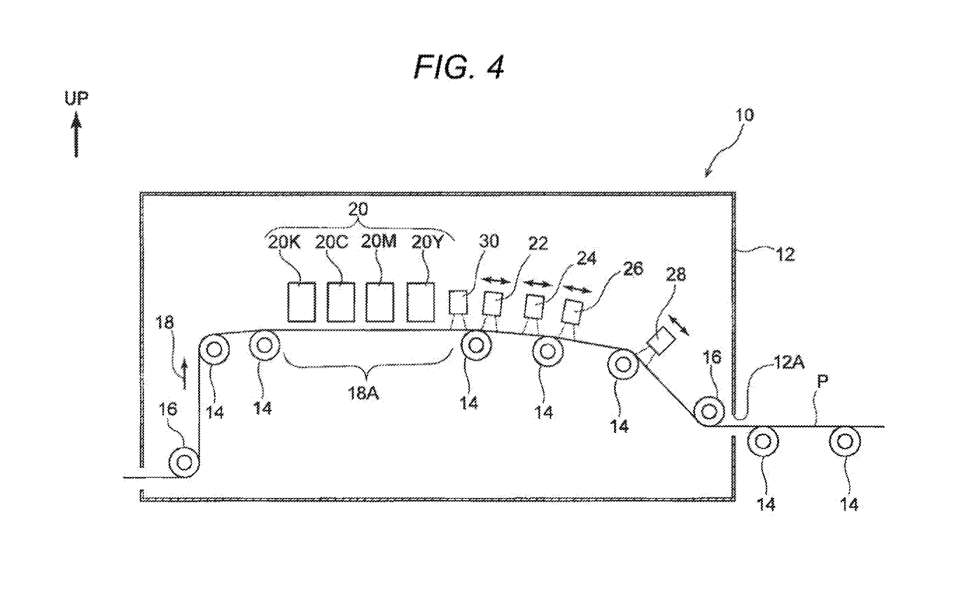

As shown in FIG. 4, in the inkjet recording device 10 according to the third exemplary embodiment, the movable laser device 22 is not disposed between the black (K) inkjet recording head 20K and the cyan (C) inkjet recording head 20C, and the movable laser devices 22, 24, 26, and 28 are disposed on only the downstream side of the most downstream side yellow (Y) inkjet recording head 20Y, in the same manner as that of the second exemplary embodiment.

In the inkjet recording device 10 according to the third exemplary embodiment, a fixed infrared ray irradiation device (hereinafter, referred to as a “fixed laser device”) 30 which radiates the infrared ray toward the continuous paper P to be transported to the transporting path 18 is disposed between the most downstream side yellow (Y) inkjet recording head 20Y and the most upstream side movable laser device 22 (on the downstream side in relation to the most downstream side inkjet recording head 20Y and on the upstream side in relation to the most upstream side movable laser device 22).

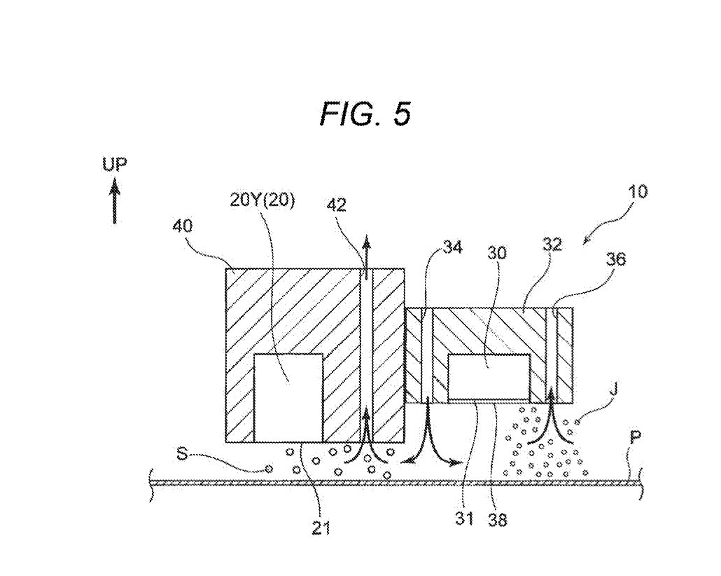

As shown in FIG. 5, the fixed laser device 30 is attached to a lower portion of a housing 32 which is fixed to the apparatus main body 12 of the inkjet recording device 10 such that an irradiated surface 31 thereof is attached toward the continuous paper P (transporting path 18). A blowing flow channel 34 for blowing air to the continuous paper P is disposed on the upstream side of the housing 32. A suction flow channel 36 for sucking a water vapor J between the continuous paper P and the fixed laser device 30 is formed on the downstream side of the housing 32.

In addition, the most downstream side yellow (Y) inkjet recording head 20Y is also attached to the lower portion of a housing 40 which is fixed to the apparatus main body 12 of the inkjet recording device 10 such that a nozzle surface 21 thereof is attached toward the continuous paper P (transporting path 18). A suction flow channel 42 for sucking an ink mist S floating between the continuous paper P and the inkjet recording head 20Y is formed on the downstream side of the housing 40.

In addition, the housing 40 and the casing 32 are bonded to each other in the transporting direction. That is, the side surface of the downstream side of the housing 40 and the side surface of the upstream side of the casing 32 are bonded to each other. According to this, a position in the transporting direction between the yellow (Y) inkjet recording head 20Y and the fixed laser device 30 are constantly maintained. The irradiated surface 31 of the fixed laser device 30 is covered with a guard glass 38.

The fixed laser device 30 is also disposed along the transporting path 18 so as to radiate the infrared ray from the normal direction of the continuous paper P in the side view shown in FIG. 4 when viewed from a direction orthogonal to the transporting direction of the continuous paper P. That is, the fixed laser device 30 is also disposed such that the optical axis thereof agrees with the normal direction of the continuous paper P.

In the inkjet recording device 10, which is configured as described above, according to the third exemplary embodiment, the operation thereof will be described below. Since the operation caused by the movable laser devices 22, 24, 26, and 28 is common with the first and the second exemplary embodiments, the operation caused by providing the fixed laser device 30 will be described here.

On the upstream side of the fixed laser device 30, air is blown from the blowing flow channel 34 onto the continuous paper P. That is, an air current for removing the ink mist S floating around the continuous paper P (between the continuous paper P and the inkjet recording head 20Y) by the suction flow channel 42 is formed. Accordingly, as compared to a configuration in which the air current is not formed, it can be suppressed that the guard glass 38 which covers the irradiated surface 31 of the fixed laser device 30 is contaminated with the ink mist S.

In addition, since the air is blown from the blowing flow channel 34 toward onto the continuous paper P, an air current for removing the water vapor J around the continuous paper P (between the continuous paper P and the fixed laser device 30) by the suction flow passage 36 is formed on the upstream side of the fixed laser device 30. Accordingly, as compared to a configuration in which the air current is not formed, it can be suppressed that dew condensation occurs on the guard glass 38 which covers the irradiated surface 31 of the fixed laser device 30.

In this way, since the fixed laser device 30, in which the position between the most downstream side inkjet recording head 20Y and the fixed laser device 30 is constant, is disposed in the inkjet recording device 10 according to the third exemplary embodiment, the vapor J around the continuous paper P or the ink mist S floating around the continuous paper P can be efficiently removed as compared to a configuration in which only plural (for example, five) movable laser devices are disposed on the downstream side of the most downstream side inkjet recording head 20Y.

Hereinabove, the inkjet recording device 10 according to the exemplary embodiment has been described in accordance with the drawings. However, the inkjet recording device 10 according to the exemplary embodiment is not limited to the illustrated configuration; and suitable design modifications may be applied within a scope not departing from the gist of the present invention. For example, the recording medium is not limited to the continuous paper P and may be a cut paper (plain paper).

In addition, each of the movable infrared my irradiation device and the fixed infrared ray irradiation device may be a structure irradiating the infrared ray and it is not limited to the laser. For example, each of the movable infrared ray irradiation device and the fixed infrared ray irradiation device may be configured by a light emitting diode (LED), an infrared heater, or the like which is capable of irradiating the infrared ray.

In addition, in FIG. 1, the fixed laser device 30 may be disposed between the yellow (Y) inkjet recording head 20Y and the movable laser device 24, and the movable laser device 22 is used as the fixed laser device 30. Furthermore, each fixed laser device 30 may be disposed on the downstream side of each color of the inkjet recording heads 20K. 20C, 20M, and 20Y, and only the movable laser device 22 may be disposed on the downstream side of the most downstream side fixed laser device 30.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A droplet ejection device, comprising:
a droplet ejection head in which a longitudinal direction thereof is aligned with a width direction of a recording medium and that forms an image by ejecting a droplet onto the recording medium to be transported along a transporting path, the droplet ejection head including black, cyan, magenta, and yellow recording heads in that order with respect to a transporting direction of the recording medium; and
four or more movable infrared ray irradiation devices that evaporate moisture in the image formed on the recording medium, one of the movable infrared ray irradiation devices being movably disposed between the black recording head and the cyan recording head with respect to the transporting direction of the recording medium, and three of the movable infrared ray irradiation devices being movably disposed on a downstream side of the yellow recording head with respect to the transporting direction of the recording medium.

2. The droplet ejection device according to claim 1, further comprising:
a fixed infrared ray irradiation device that is provided in a housing which is fixed on the downstream side of the recording medium in the transporting direction in relation to the droplet ejection head and on an upstream side of the recording medium in the transporting direction in relation to the three or more movable infrared ray irradiation devices and that evaporates moisture in the image formed in the recording medium;
a blowing flow channel for blowing air to the recording medium which is formed in the housing on the upstream side of the recording medium in the transporting direction in relation to the fixed infrared ray irradiation device; and
a suction flow channel for sucking water vapor around the recording medium which is formed in the housing on the downstream side of the recording medium in the transporting direction in relation to the fixed infrared ray irradiation device.

3. The droplet ejection device according to claim 1,
wherein the four or more movable infrared ray irradiation devices are disposed along the transporting path so as to radiate an infrared ray from a normal direction of the recording medium, in a side view when viewed from a direction orthogonal to the transporting direction of the recording medium.

4. The droplet ejection device according to claim 3,
wherein the infrared ray is radiated from the normal direction of the recording medium that is not horizontal.

5. A droplet ejection device, comprising:
a droplet ejection head in which a longitudinal direction thereof is aligned with a width direction of a recording medium and that forms an image by ejecting a droplet onto the recording medium to be transported along a transporting path;
three or more movable infrared ray irradiation devices that are movably disposed on a downstream side of the droplet ejection head with respect to a transporting direction of the recording medium in relation to the droplet ejection head and that evaporate moisture in the image formed on the recording medium;
a fixed infrared ray irradiation device that is provided in a housing which is fixed on the downstream side of the recording medium in the transporting direction in relation to the droplet ejection head and on an upstream side of the recording medium in the transporting direction in relation to the three or more movable infrared ray irradiation devices and that evaporates moisture in the image formed in the recording medium;
a blowing flow channel for blowing air to the recording median which is formed in the housing on the upstream side of the recording medium in the transporting direction in relation to the fixed infrared ray irradiation device; and
a suction flow channel for sucking water vapor around the recording medium which is formed in the housing on the downstream side of the recording medium in the transporting direction in relation to the fixed infrared ray irradiation device,
wherein the housing of the fixed infrared ray irradiation device is bonded to the droplet ejection head on a downstream side of the droplet ejection head,
a separate suction flow channel for sucking ink mist floating between the recording medium and the recording head is formed on the downstream side of the droplet ejection head.

6. The droplet ejection device according to claim 5,
wherein the three or more movable infrared my irradiation devices are disposed along the transporting path so as to radiate an infrared ray from a normal direction of the recording medium, in a side view when viewed from a direction orthogonal to the transporting direction of the recording medium.

7. The droplet ejection device according to claim 6,
wherein the infrared ray is radiated from the normal direction of the recording medium that is not horizontal.
